(19) United States
(12) Patent Application Publication
(10) Pub. No.: US 2025/0200738 A1
(43) Pub. Date: Jun. 19, 2025

(54) Efficient Deep Learning Inference of a Neural Network for Line Camera Data

(71) Applicant: Siemens Aktiengesellschaft, München (DE)

(72) Inventors: Ingo Thon, Grasbrunn (DE); Alexander Michael Gigler, Untermeitingen (DE)

(73) Assignee: Siemens Aktiengesellschaft, München (DE)

(21) Appl. No.: 18/844,255

(22) PCT Filed: Feb. 13, 2023
(86) PCT No.: PCT/EP2023/053479

§ 371 Date: Sep. 5, 2024

(30) Foreign Application Priority Data
Mar. 7, 2022 (EP) 22160416.8

(51) Int. Cl. G06T 7/00; H04N 25/701

(52) U.S. Cl. CPC G06T 7/0004; H04N 25/701; G06T 2207/20084; G06T 2207/30164

(57) ABSTRACT

Various embodiments of the teachings herein include a method for accelerating deep learning inference of a neural network with layers. An example includes: generating a line-wise image consisting of pixels by a line-camera scanning an object; and for each generated new pixel-line, for calculations in the current layer which do not involve the new pixel-line, using results of previous calculations instead of repeating a calculation of a value of a pixel in the next layer.

### CROSS-REFERENCE TO RELATED APPLICATIONS

This application is a U.S. National Stage Application of International Application No. PCT/EP2023/053479 filed Feb. 13, 2023, which designates the United States of America, and claims priority to EP Application Serial No. 22160416.8 filed Mar. 7, 2022, the contents of which are hereby incorporated by reference in their entirety.

### TECHNICAL FIELD

The present disclosure relates to neural networks. Various embodiments of the teachings herein include methods and/or systems for accelerating deep learning inference of a neural network with layers.

### BACKGROUND

Deep learning inference is the process of using a trained deep neural network (DNN) model to make predictions against previously unseen data. Optical Inspection with Artificial Intelligence (AI) is an emerging topic in industrial automation. Algorithms and hardware for efficient inference exist in the context of rectangular (Area scan) field of interest/region of interest. Efficient hardware for inference with a low thermal design power plays a crucial role in industrial automation, whether it is IPCs or specialized hardware for inference like the SIMATIC™ NPU of Siemens AG. Accelerator chips for Industrial Personal Computers are for example Google's Coral or Intel's Myriad or Movidius.

Nevertheless, most accelerators with low thermal design power have been developed for mobile applications like in cell phones where lower resolution images are sufficient, e.g., to detect faces. Typically, such image resolutions are in the range from 32×32 pixel up to a typical maximum of 1024×768 pixels. However, in industrial applications much higher resolutions are necessary to fulfill the intended task. This is especially true in the context of continuous production, e.g., in steel production, inspection of fabric, inspection of paper and printing products, or when objects are transported on a conveyor belt and should be analyzed continuously without stopping the conveyor. In the latter case, the predominant image sensor is a so-called line camera.

A line camera does not acquire single rectangular images but generates a constant stream of vectors (dimensionality: spatial resolution of the line-scan×color bands: greyscale: 1 or RGB: 3), on a wide but extremely narrow sensor. Typical resolutions are from 2048×1 px up to 12288×3 px. However, the line frequency can easily go up to 50 khz. Hence, a line camera of 2048×1 px and a line frequency of 1 kHz generates an image of 2048×1000 px per second. For product and quality inspection tasks such high resolutions are necessary.

Evaluating such high resolutions with the (accelerator) chipsets for the mobile market is impossible according to state of the art. In modern applications utilizing Hyper-Spectral-Imaging (HSI) cameras, the problem becomes even worse as these cameras do not only generate three colors (RGB) but have a much higher wavelength resolution in terms of the colors of the light, i.e., spectral features or bands. Spectrally, this can be used in the visible range, but also in the more interesting near or mid-infrared range where the data can be correlated with the chemical composition or physical properties of the sample. Due to the higher spectral resolution and increased information content, better detection/contrasting of structures is achieved. In the mid- and far-infrared range even highly specific chemical sensing is possible due to the sharp spectral features there, yet, coming at much higher prices.

The state of the art is to aggregate the pixels measured individually into a single rectangular image. Thus, the stream to be evaluated by the artificial intelligence is put into rectangular chunks. This either requires large strides (skipping over parts of the inference task), risking loosening: information or using extremely expansive GPUs for inference.

### SUMMARY

The teachings of the present disclosure provide various solutions for improving deep learning inference of optical inspections in the field of industrial automation. For example, some embodiments of the teachings herein include a computer-implemented method for accelerating deep learning inference of a neural network with layers, whereby a line-wise image consisting of pixels is generated by a line-camera (1) scanning an object (3), characterized by: for each generated new pixel-line, for calculations in the current layer, which do not involve the new pixel-line, results of previous calculations are re-used instead of repeated calculations to calculate the value of a pixel in the next layer.

In some embodiments, if the input size of the neural network is constant, for each new pixel-line the oldest pixel-line and calculations which involved the oldest pixel-line are removed.

In some embodiments, the neural network is a convolutional neural network, and the pixels of the layers are calculated by convolution using a convolutional kernel.

In some embodiments, for each layer: initializing a first-in-first-out buffer unit with at least the size of the vertical resolution of the layer minus one, for initialization, putting the next line of the image in the buffer unit until the horizontal resolution of the convolutional kernel minus the figure one is reached, whereby for each line in the layer: adding the line to the buffer unit, calculating the convolution on the content of the buffer unit, whereby previously calculated values are stored for the next line, and providing the calculated convolution on the content to the next layer.

In some embodiments, the object (3) is a part processed in a production process in a factory.

In some embodiments, the line-camera (1) is set-up in a production line (4).

In some embodiments, the neural network's stride is set to a whole integer greater one, therefor in one iteration step multiple lines from the input calculate only one output.

In some embodiments, the method is performed for every color channel of the line-camera (1).

As another example, some embodiments include an arrangement for accelerating deep learning inference, comprising a neural network with layers and a line-camera (1) scanning an object (3), whereby the line-camera (1) is designed to generate a line-wise image consisting of pixels; characterized by: a computational device (2) comprising the neural network, designed, and programmed to for each generated new pixel-line re-use for calculations in the current layer, which do not involve the new pixel-line, results of previous calculations instead of repeated calculations to calculate the value of a pixel in the next layer.

In some embodiments, if the input size of the neural network is constant, for each new pixel-line the oldest pixel-line and calculations which involved the oldest pixel-line are removed.

In some embodiments, the neural network is a convolutional neural network, and the computational device (2) is designed to calculate the pixels of the layers by convolution using a convolutional kernel.

In some embodiments, the computational device (2) is designed to carry out the steps of claim 4.

In some embodiments, the object (3) is a part processed in a production process in a factory.

In some embodiments, the line-camera (1) is set-up in a production line (4).

In some embodiments, the neural network's stride is set to a whole integer greater one, therefor in one iteration step multiple lines from the input calculate only one output.

### BRIEF DESCRIPTION OF THE DRAWINGS

Further benefits and advantages of teachings of the present disclosure are apparent after a careful reading of the detailed description with appropriate reference to the accompanying drawings. In the drawings:

FIG. 1 shows an illustration of calculation of one single output pixel;

FIG. 2 shows an illustration of the calculation for two different channels;

FIG. 3 shows a two-layer architecture;

FIG. 4 shows the reduction of buffer compacity; and

FIG. 5 shows a block diagram of an example arrangement incorporating teachings of the present disclosure.

### DETAILED DESCRIPTION

The teachings of the present disclosure include various embodiments. An example includes an automated method for accelerating deep learning inference of a neural network with layers, whereby a line-wise image consisting of pixels is generated by a line-camera scanning an object, whereby: for each generated new pixel-line, for calculations in the current layer, which do not involve the new pixel-line, results of previous calculations are re-used instead of repeated calculations to calculate the value of a pixel in the next layer. Thus, calculation effort is reduced and therefor customers can utilize more complex imagery in less expansive hardware. The savings for the customer comes from the fact that there is no need for expansive computer graphics cards for inference. These benefits can be either be monetarized directly or utilized to improve the attractiveness of programmable logic controllers.

In some embodiments, if the input size of the neural network is constant, for each new pixel-line the oldest pixel-line and calculations which involved the oldest pixel-line are removed.

In some embodiments, the neural network is a convolutional neural network, and the pixels of the layers are calculated by convolution using a convolutional kernel.

In some embodiments, for each layer:
a first-in-first-out buffer with at least the size of the vertical resolution of the layer minus one is initialized,
for initialization, putting the next line of the image in the buffer until the horizontal resolution of the convolutional kernel minus the figure one is reached,
   whereby for each line in the layer:
adding the line to the buffer,
calculating the convolution on the content of the buffer, whereby previously calculated values are stored for the next line, and
providing the calculated convolution on the content to the next layer.

In some embodiments, the object is a part processed in a production process in a factory.

In some embodiments, the line-camera is set-up in a production line.

In some embodiments, the neural network's stride is set to a whole integer greater one, therefor in one iteration step multiple lines from the input calculate only one output. In result, the number of buffers is significantly reduced.

In some embodiments, the method is performed for every color channel of the line-camera.

In some embodiments, there is an arrangement for accelerating deep learning inference, comprising a neural network with layers and line-camera scanning an object, whereby the line-camera is designed to generate a line-wise image consisting of pixels. The arrangement is characterized by a computational device designed and programmed to be applied to every new pixel-line added to the image. This is resulting in previous calculations for pixels of the current layer instead of repeated calculations to calculate the value of a pixel in the next layer.

In some embodiments, the neural network is a convolutional neural network, and the computational device is designed to calculate the pixels of the layers by convolution using a convolutional kernel.

In some embodiments, the computational device is designed to carry out one or more of the methods described herein.

In some embodiments, the object is a part processed in a production process in a factory.

In some embodiments, the line-camera is set-up in a production line.

In some embodiments, the neural network's stride is set to a whole integer greater one, therefor in one iteration step multiple lines from the input calculate only one output.

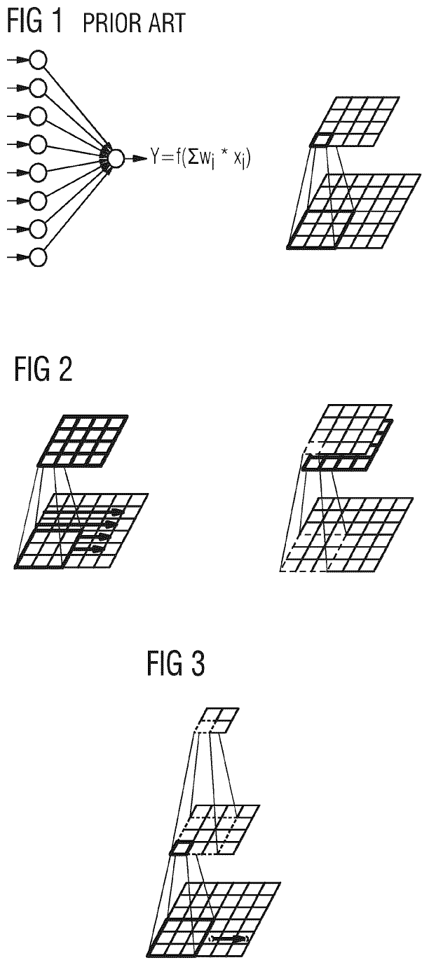

A convolutional deep neural network is built up from various so-called convolutional layers. Each convolutional layer contains a series of filters known as convolutional kernels. A convolutional kernel is a simple but efficient mathematical formulation. The kernel is a matrix of integers that are used on a subset of the input pixel values, the same size as the kernel. Each pixel is multiplied by the corresponding value in the kernel, then the result is summed up for a single value for simplicity representing a grid cell, like a pixel, in the output channel/feature map. As an example, a 3×3 convolutional kernel takes a patch of 3×3 pixels from the input and calculates one value for the output layer. The image of FIG. 1 illustrates the calculation of one single output pixel (see right side, top patch) from a 3×3 patch in the input (see right side, bottom patch). In the left diagram, the mathematical calculation, where the 9 pixels from the input xi multiplied by a weight vector wᵢ, is depicted. The weight vector wᵢ is determined by the training/learning procedure of the deep neural network.

This calculation is repeated for each patch of the input data (next image, left side of FIG. 1) and often multiple times for various weight vectors (next image, right side of FIG. 1) when performing the calculation for different channels as shown in FIG. 2 for two channels (e.g., two colors). In the input based on image data, there are typically three channels for the colors red, green, and blue, while in hyperspectral imaging (HSI) application around 256 channels constitute the input data.

This generates a notable amount of calculation on the input data and following in all subsequent convolutional layers of the deep neural network. In cameras applications with line patching/scanning the images the calculations are repeated multiple times.

The teachings of the present disclosure may be used to automatically extend the line-wise nature of the line-camera to the inference calculation in the deep neural network. Instead of patching the input image in repeated image parts, the previous calculations are either contained/implemented in the software or in the inference model, where the latter approach may be more efficient.

For illustrative purposes consider a two-layer architecture according to FIG. 3. For inference, the network needs to execute in the first layer 4×4 calculations and in the next layer it needs to calculate 2×2 calculations. Hence, the intended algorithm works as follows for each layer:
1.) Initialize a first-in-first-out buffer (=buffer unit) with the size of the vertical resolution of the layer.
2.) For initialization, put the next line in the buffer until the horizontal (=direction of the feed motion) resolution−1 of the convolutional kernel is reached.
3.) For each line
   a. add the line to the buffer
   b. calculate the convolution on the content of the buffer, whereby previously calculated values are stored for the next line,
   c. provide the content (calculated convolution) to the next layer.

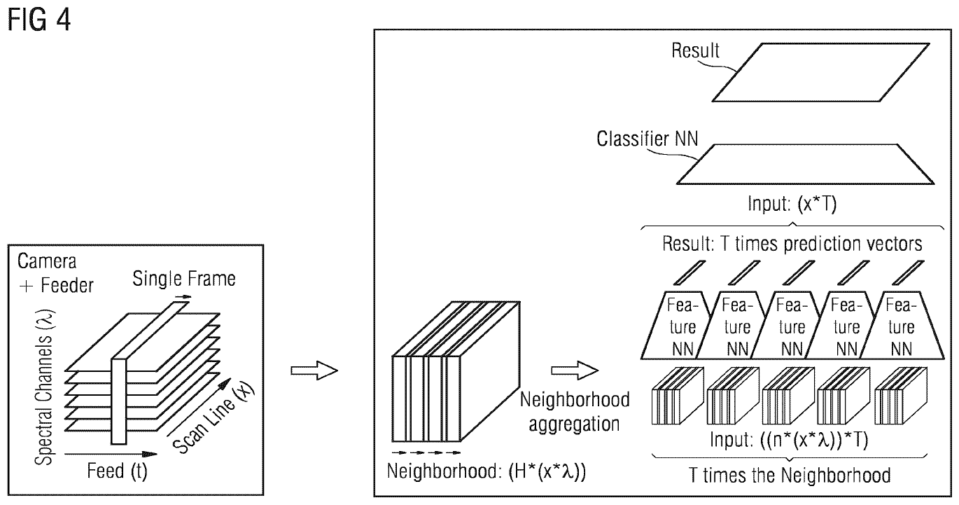

This algorithm can be implemented extremely efficiently in-silico when implemented in computational memory. This may shift the effort from computations to memory due to the ring buffers. This gets, however, critical when the number of channels, e.g., in HSI applications increases. Therefore, the teachings may save buffers in inference by utilizing Neural Architecture search training a so-called super-network. The super-network as shown in FIG. 4 contains options for large strides in vertical direction in the input. A stride consumes in one iteration not a single line but multiple lines from the input (four neighborhood lines in FIG. 4) and calculates only one output. In result, the number of buffers collapses significantly as indicated in FIG. 4 by the frustums.

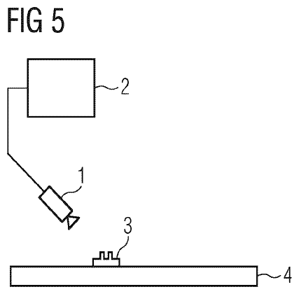

FIG. 5 shows a block diagram of an example arrangement incorporating teachings of the present disclosure. An object 3 is processed in a production line 4 and inspected by a line-camera 1. The images of the line-camera 1 are processed in the computational device 2 which comprises the deep neural network performing the inference.

Although the teachings have been explained in relation to example embodiments as mentioned above, it is to be understood that many other possible modifications and variations can be made without departing from the scope of the present disclosure. It is, therefore, contemplated that the appended claim or claims will cover such modifications and variations that fall within the true scope thereof.

What is claimed is:

1. A method for accelerating deep learning inference of a neural network with layers, the method comprising:
generating a line-wise image consisting of pixels by a line-camera scanning an object; and
for each generated new pixel-line,
for calculations in the current layer, which do not involve the new pixel-line, using results of previous calculations instead of repeating a calculation of a value of a pixel in the next layer.

2. The method according to claim 1, further comprising removing the oldest pixel-line and associated calculations if the input size of the neural network is constant, for each new pixel-line.

3. The method according to claim 1, wherein:
the neural network comprises a convolutional neural network; and
calculating the pixels of the layers includes using a convolutional kernel.

4. The method according to claim 3, further comprising, for each layer:
initializing a first-in-first-out buffer unit with at least the size of the vertical resolution of the layer minus one;
for initialization, putting the next line of the image in the buffer unit until the horizontal resolution of the convolutional kernel minus the figure one is reached; and
for each line in the layer:
adding the line to the buffer unit,
calculating the convolution on the content of the buffer unit, whereby previously calculated values are stored for the next line, and
providing the calculated convolution on the content to the next layer.

5. The method according to claim 1, whereby wherein the object comprises a part processed in a production process in a factory.

6. The method according to claim 1, wherein the line-camera is set-up in a production line.

7. The method according to claim 1, wherein the neural network's stride is set to a whole integer greater one, therefor in one iteration step multiple lines from the input calculate only one output.

8. The method according to claim 1, further comprising performing the method for every color channel of the line-camera.

9. An arrangement for accelerating deep learning inference, the arrangement comprising:
a neural network with layers;
a line-camera to scan an object and generate a line-wise image of the object using pixels;
wherein the neural network, for each generated new pixel-line, re-uses results of previous calculations instead of repeated calculations to calculate the value of a pixel in the next layer for calculations in the current layer which do not involve the new pixel-line.

10. The arrangement according to claim 9, further comprising removing the oldest pixel-line and calculations which involved the oldest pixel-line if the input size of the neural network is constant for a new pixel-line.

11. The arrangement of claim 8, wherein:
the neural network comprises a convolutional neural network to calculate the pixels of the layers by convolution using a convolutional kernel.

12. (canceled)

13. The arrangement according to claim 8, wherein the object comprises a part processed in a production process in a factory.

14. The arrangement according to claim 8, wherein the line-camera is set-up in a production line.

15. The arrangement according to claim 8, wherein the neural network's stride is set to a whole integer greater one, therefor in one iteration step multiple lines from the input calculate only one output.
